(19) United States
(12) Patent Application Publication
(10) Pub. No.: US 2008/0044546 A1
(43) Pub. Date: Feb. 21, 2008

(54) Product and method for providing texture, aroma, and flavor to microwave popcorn

(76) Inventors: Michael Jensen, Omaha, NE (US); Lance Schilmoeller, Omaha, NE (US); Jamie Sloneker Halgerson, Omaha, NE (US); Gordon Smith, Omaha, NE (US)

Correspondence Address: SUITER SWANTZ PC LLO, 14301 FNB PARKWAY, SUITE 220, OMAHA, NE, 68154, US

(21) Appl. No.: 11/893,978

(22) Filed: Aug. 17, 2007

Related U.S. Application Data
(60) Provisional application No. 60/838,668, filed on Aug. 18, 2006.

(51) Int. Cl. A23D 7/00; A23L 1/00; A23L 1/22; A23L 1/237

(52) U.S. Cl. 426/601; 426/649; 426/650

(57) ABSTRACT

A technique and process for preparation of a texturized microwave popcorn product is disclosed. A solid concentrated texturizing composition in a compact form is utilized in a microwavable popcorn bag. The solid concentrated texturizing blend is melted during cooking and dispersed over the popped popcorn as part of the popping process, resulting in a texturized popped microwave popcorn product.

### CROSS-REFERENCE TO RELATED APPLICATIONS

The present application claims the benefit under 35 U.S.C. §119(e) of U.S. Provisional Application Ser. No. 60/838,668, filed Aug. 18, 2006, incorporated herein by reference.

### TECHNICAL FIELD

The present disclosure relates to microwave popcorn, and more particularly compositions and methods for providing microwave popcorn with a texture, aroma, and/or flavor.

### BACKGROUND

Microwave popcorn products have become popular consumer items. The product may be provided to the consumer in a form including unpopped popcorn enclosed within a disposable microwave package or container, such as a paper or fiberboard container. The consumer product may be utilized by placing the microwave package, with the unpopped popcorn therein, in a conventional microwave oven. After exposure to microwave energy in a conventional oven for about 1-5 minutes, the popcorn may convert to a popped form for consumption. The composition within the microwave popcorn package may include other food additives.

### SUMMARY

Products and processes for providing a microwave popcorn product with improved texture, aroma, and flavor are disclosed. In general, compositions are defined which may be used for providing microwave popcorn with a texture, aroma, and/or flavor utilizing the microwave process. A process is provided in which the texturizing composition may be provided in the original microwave package with the unpopped microwave popcorn. During the microwaving, the texture may be generated as the popcorn is popped.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the general principles.

### BRIEF DESCRIPTION OF THE DRAWINGS

FIG. 1 is a schematic depiction of a microwave popcorn package stored in an over wrap, which may contain an unpopped popcorn charge, a texturizing composition, and slurry as described therein.

FIG. 2 is a schematic top plan view of the microwave popcorn package of FIG. 1, shown removed from the over wrap and unfolded generally as it would be for use in a microwave;

FIG. 3 is a schematic plan view of a package blank from which the package of FIG. 2 can be formed;

FIG. 3A is a schematic plan view of a package blank for forming a mini bag, usable with principles according to the present disclosure;

FIG. 4 is a cross-sectional view taken along line 5-5, FIG. 2;

FIG. 5 is a schematic perspective view of a tub arrangement useable with a texturing composition according to the present disclosure; and

FIG. 6 is a cross-sectional view of the tub arrangement in FIG. 5 depicting the charge of unpopped popcorn, solid compact texturizing composition, and slurry described below.

### DETAILED DESCRIPTION

Reference will now be made in detail to the subject matter disclosed, which is illustrated in the accompanying drawings.

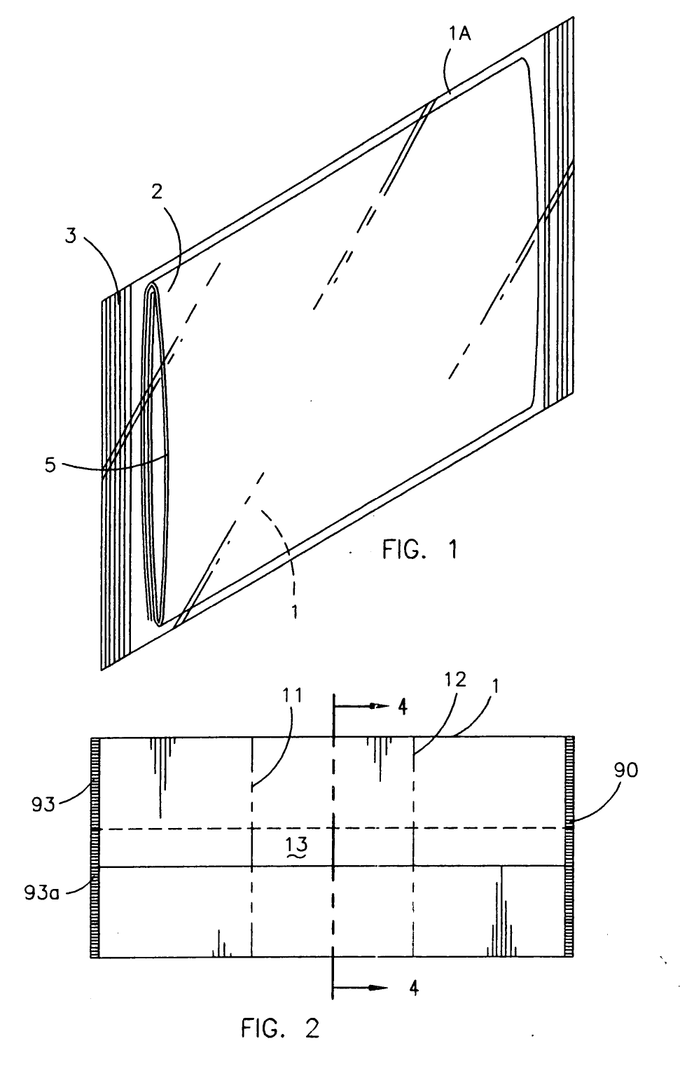

Referring generally to FIGS. 1 through 6, a microwave popcorn article having a texturizing composition for providing the microwave popcorn article with an improved texture, aroma, and/or flavor and a method for utilizing the texturizing composition are disclosed. Throughout this disclosure, the term “texturizing composition” includes any composition that provides texture, aroma and/or flavor. Additionally, a “microwave popcorn product” generally refers to any microwave popcorn product including unpopped popcorn kernels. A “texturized microwave popcorn product” generally refers to any microwave popcorn product including popped popcorn kernels at least partially covered with a texturizing composition. In general, the microwave popcorn article may include popcorn kernels, a slurry including an edible oil and/or an edible fat, and a texturizing composition for providing an improved texture, aroma, and/or flavor. As the popcorn kernels are popped, the texturizing composition may melt. The resulting liquid phase may be at least partially dispersed over the popped popcorn for forming a texturized popped microwave popcorn product.

### I. MICROWAVE POPCORN

The present disclosure relates to a microwave popcorn article in which the texture on the popcorn provides:

a. A desirable, shiny, glossy appearance and feel reminiscent in appearance of a candy-coated product, such as traditional candy coated popcorn (non-microwavable);

b. Acceptable characteristics to the touch;

c. Acceptable texture, crunch, taste and mouth feel when eaten and a softer crunch than a traditional candy coating; and/or

d. Texture, aroma, and/or flavoring.

With respect to appearance, popcorn flakes nearly completely coated with a shiny glaze, for example found in commercial caramel corn products, is not the intended result. Rather, a distribution of a crunchy, candy like, glaze on the various popcorn flakes, without requiring complete or substantially complete coating, is typically enough for an acceptable, microwave, texturized popcorn product, although complete coating is contemplated by this disclosure.

Desirable characteristics to the touch may involve a variety of factors and characteristics. As the texturized microwave popcorn product is removed from the microwave oven, it should not be sticky to the touch. A sticky popcorn coating may be uncomfortable to handle and transfer and may transfer undesirable levels of heat to the fingers. The popcorn should not be fused together by the texturizing composition into a single mass, defining one large, hard to handle, solid clump that is not friable or easily separated into manageable pieces.

Texturized microwave popcorn products should provide for the mouth feet (crunch, texture, etc.) reminiscent of a glazed popcorn made with a glaze applied by radiant heat. However, unlike with pre-popped popcorn coated with a syrup/sugar glaze (applied with a radiant heat process) with a microwave popcorn product the crunchy texturing itself (if without added sweetener) may not be sufficiently sweet for providing a sweet candy taste. Rather, sweetness may be imparted to the product through addition of a sweetener, sometimes included within the popcorn composition prior to texturing compound, sometimes added with the texturing compound.

In more general terms, candy coating processes often involve a syrup formed by heating a mixture of corn syrup and sugar and driving excess moisture out of the mixture. The syrup may be sprayed onto (or otherwise mixed with) pre-popped popcorn for providing coated popcorn. Such coatings are generally very sweet, and a relatively large amount of coating (about 5 parts by wt. glazing syrup per 1 part popped popcorn) may be used. Further, such syrups may need to be carefully heated for avoiding burning.

### II. EXEMPLARY MATERIALS

In addition to materials disclosed in the provisional application for improving the texture, aroma, and/or flavoring, other materials may be currently preferred and may be discussed in detail below. It may be desirable that the texturizing composition comprise a material having a glass transition temperature (Tg) of no more than about 80° C., and typically no greater than about 70° C., usually 60° C. or lower, and typically about 35° C. or higher, for example 40° C.-60° C. Such a material may convert from a solid state to form the texture within a relatively short period of time when exposed to a “high” setting in a typical microwave. Additionally, it may provide a texture, aroma, and/or flavor without becoming excessively hot or sticky and uncomfortable for the consumer to handle after the microwaving.

Further, it may be desirable that the relative amount of texturizing composition for popped popcorn be such that only relatively low amounts, by weight, of the texturizing composition may be added to the popped popcorn to obtain a desirable texture. This may ensure the texture is not unacceptably thick once formed, and the texturized microwave popcorn product, in spite of not being stirred during texturizing, is not fused into a large, hard to manage, mass. This desirable characteristic may be facilitated by having the texturizing composition provided primarily in a concentrated solid form or a compact solid form (also referred to as a compact form) so that it may easily be distributed widely throughout the popped popcorn. A compact solid form may include various shapes, including a sphere, an oval, a cylinder, a cube, a disk, a rectangle, a pellet, or any other geometries and/or shapes, including other irregular and/or inconsistent shapes and sizes. The compact solid form may be referred to as pellets, tablets, or particles.

The texturizing composition in a compact solid form, also referred to as texturizing pellets or a concentrated solid form, may include texturizing pellets having a combination of colors and/or flavors. Texturizing pellets may be a concentrated solid form of texturizing composition. During popping, the pellets, because each pellet is in a concentrated form, may experience a delay in melting. Delayed melting of a concentrated texturizing pellet may be advantageous because of decreased scorching potential. Any sugar present in a texturizing composition may be scorched by salt also present in a popcorn slurry in contact with the texturing composition. A texture in the form of a concentrated texturizing pellet may decrease the area exposed to a popcorn slurry including salt. This decreased area that is exposed may decrease or eliminate the amount of texturizing composition that may be scorched in the final improved microwave popcorn product.

Additionally, a texturizing composition in a concentrated and/or compact form, such as a pellet, may decrease the amount of oil or fat otherwise needed in the popcorn slurry resulting in a reduced amount of fat per serving. Utilizing a texturizing composition in a concentrated form may allow more texturizing composition to be utilized per amount of fat and/or oil slurry because the concentrated form may have Less surface area than a particulate form and may require less surface area for heating and melting the texturizing composition.

Each pellet may have a distinct color and/or flavor and may distribute the flavor and color over the popped popcorn during the popping process. This may allow for a customized flavor and/or appearance of the final microwave popcorn product. When the texturizing composition melts, the particular color and/or flavor of a particular texturizing composition pellet may be distributed Locally on the popped popcorn. This may provide multiple colors and/or flavors throughout the overall textured microwave popcorn product and the ability to deliver multiple flavors while keeping the flavors and/or colors separate. Further, the slurry may deliver at least one flavor different than a flavor delivered by the texturizing composition.

A particular flavor may be delivered to a food product by including it in a texturizing composition pellet. A particular flavor may only be delivered by a texturizing composition pellet. For example, a butter flavor may be delivered only as a component in a texturizing composition in a pellet form even though butter flavoring is generally included as part of a popcorn slurry. A variety of flavors may be provided in the texturizing composition for providing a variety of microwave popcorn products. Examples may include cotton candy, cinnamon, caramel, apple, caramel apple, butter pecan, coffee, toffee and green apple. Other flavors and combinations of flavors may be utilized.

Microwave popcorn compositions may be formulated based upon the amount of unpopped popcorn kernels, as opposed to the weight of popped popcorn. Thus, herein the amount of texturizing composition added to the popped popcorn may be defined with respect to the amount of texturizing composition added to popped popcorn resulting from a defined amount of unpopped popcorn. The amount of texturizing composition added may be referred to as being in at least a “texturizing effective amount.” The term “texturizing effect of amount” may mean a minimum addition which provides the appearance and mouth feel similar to a texture. The weight ratio of texturizing composition to unpopped kernel may be at least 0.06, not more than 0.6, and typically 0.08 to 0.4 when techniques described herein are practiced. The texturizing composition may be provided in an amount, based upon weight of unpopped popcorn kernels, within the range of about 6%-60%, typically 8%-40%.

Various color agents may be provided in the texturizing composition, for obtaining a desirable color to the texture and final food product. The color may be selected to correspond with the flavor. For example a cotton candy flavor may be provided with a pink color, a cinnamon flavor may be provided with a dark red color, etc. Additionally, the color may be chosen on seasonal or holiday themes, for example green for St. Patrick's Day, orange for Halloween, etc.

Additionally, various aromatic agents may be included in the texturizing composition. An aromatic component in the texturizing composition may allow for a controlled release of a desired aroma from the texturing composition and from the texturized microwave popcorn product. The aromatic component may be configured to compliment the flavor and appearance of the texturized microwave popcorn product. Further, the aromatic component may be configured to not be tasted. Moreover, the aromatic component may be encapsulated for ease in controlling a release of the aroma. The aromatic component may be located on the surface of or in a homogenous fashion throughout the texturizing composition.

The aromatic component may be released by multiple mechanisms, including time, heat, and/or physical manipulation, such as a popping action by popcorn kernels. For example, an aromatic component releasing a butter aroma may be utilized on a microwave popcorn product. When the popcorn kernels pop, the texturizing composition may be physically manipulated and/or exposed to turbulence created by the popping popcorn. Additionally, the butter aroma may be released from the texturizing composition by heating caused by the microwave energy or some other heat source. The aromatic component may contain volatile components, which may be released by increased heating. Further, the aromatic component of the texturizing composition may be released by time once a portion of the texturizing composition has been melted or otherwise physically manipulated.

The texturizing composition may be encapsulated and include a first layer and a second layer. The first layer may include a core with an aromatic component and the second layer may include a non-volatile component. The second layer may be broken or otherwise physically manipulated, and the aromatic component in the first layer may be released giving off an aroma. The texturizing composition may be encapsulated or in a homogenous form. Moreover, an encapsulated texturizing component may include multiple layers with each layer including a different color, flavor, and/or texture and each layer having a different purpose, such as providing texture, aroma, and/or flavors. For example, a core having a salt component may be a first layer and a second layer may include a texturizing composition including a sugar and/or a hydrolyzed starch. Another example may include a pellet with a liquid center. A separate example may include a pellet having a gummy second layer. The encapsulated texturizing composition may be in the form of a pellet.

The texturizing composition may not be in a form that will impart a substantially “sweet” flavor to the overall texturized popcorn, unless an artificial sweetener, such as sucralose, is provided on the product. This may be due to two factors: (a) first, the texturizing composition (if without artificial sweetener) may not include enough sugar (for example sucralose) for providing a noticeably sweet taste to the popcorn; and, (b) second, the texturizing composition (if without artificial sweetener) may not be typically applied in a large amount to the popcorn for providing the popcorn with a sweet sugar flavor.

In order to provide a sweet taste, an additional sweetener may be provided on the popcorn. As previously mentioned, a useable sweetener may be sucralose, which may provide a high flavor impact utilizing a low volume. Additionally, sucralose has been found to be relatively stable (by comparison to sucrose) under microwave conditions, even in the presence of salt. An example utilizing sucralose may be found in U.S. Patent Publications 2002/0127306 and 2003/0012853, incorporated herein by reference.

A sweetener, when used, may be characterized as being used in at least a “sweetening effective amount.” The term “sweetening effective amount” may mean an amount at least sufficient for providing at least a noticeable sweet flavor to the resulting texturized microwave popcorn product.

In some instances, it may be desirable to provide a salt in the final popcorn composition. In principle, the salt may be provided either in the microwave popcorn bag prior to cooking and/or added after the popcorn is popped and the popcorn is removed from the bag. However, it has been found that salt may contribute to a scorching problem. A scorching or burnt taste may be a result of interaction between the salt and sugar. It may be preferable to avoid salt and/or to minimize its presence.

A texturized microwave popcorn product, in accord with typical applications of the principles described, may differ from glazed popcorn made in a radiant heat “candy coat” type process. For example, a careful application of the sucrose based glazing composition is involved with such a radiant heat candy coat process. Sweetness in the popcorn may result from the texture itself, often comprising a mixture of sucrose and salt applied in an amount of about 5 to 1, per wt. of popped popcorn. The mixture of sucrose and salt may be used in lower ratio amounts. In the microwave process, the texture itself may not impart a substantially sweet taste to the popcorn even though it may include some sugar and may be used in lower amounts. When a sweet taste is desired, an additional artificial sweetener stable under microwave conditions may be utilized, such as sucralose.

The conditions for formation of a texturized popcorn may differ substantially between a process of microwaving and a process involving radiant heating. When a glaze is applied in a bowl or kettle process using radiant heat, the popcorn may either be sprayed with or stirred with the pre-heated glaze. An awkward slow spray or stirring process requiring careful control may be inconvenient for a home microwave heating system. Further, in a process of microwaving there may be particular issues related to sugar/salt combinations not found in processes involving radiant heat applications. Moreover, with a commercial microwave popcorn product, it may be desirable that the provision of a texture not involve a substantial time commitment (or awkward cooking step) after the popcorn is popped or the product may be unacceptable to the consumer.

One useable particulate food material may be appropriate for use as a component in a solid concentrated texturizing composition for a microwave popcorn process. The particulate food material may include a material originally formulated as a flavor base. It is available under the general trade designation “Ultra Seal” from Givaudan, Cincinnati, Ohio, 45216. It may be obtained from Givaudan formulated with a variety of different flavors, which may include cinnamon, cotton candy, caramel, apple, caramel apple, butter pecan, coffee, toffee and green apple. Another useable commercially available food material suitable for use in a texturizing composition for providing texture, aroma, and flavor to microwave popcorn may be available from Tate & Lyle, 2200 East Eldorado St., Decatur, Ill., 62525. One available food material available from Tate & Lyle may be product F4-853 and may include corn syrup solids and sugar, as well as other ingredients.

As discussed above, a salt may be added after the popcorn has been popped and removed from the microwave bag.

### III. GENERAL FORMULATIONS

Microwave popcorn products may be provided in a variety of sizes, depending on the amount of popcorn desired. Two popular sizes may be (a) a generally individual or small product, sometimes referred to as “mini” popcorn product, which may contain 25-35 grams of unpopped popcorn per package; and (b) a full or regular size product, which may contain about 60-80 grams of unpopped popcorn per microwave package.

Within the microwave package, along with the unpopped popcorn, a popping slurry may be provided. The term “popping slurry” may refer to all other food components with the microwave popcorn package during the popcorn popping process beside the unpopped popcorn kernels and texturizing composition. The popping slurry may be provided in an amount, by weight within the range of about 3% -60% based on unpopped popcorn.

A mini bag or product may contain about 25-50 grams of unpopped popcorn and about 1-20 grams slurry. A full or regular size bag may contain about 60-80 grams of unpopped popcorn and about 15-40 grams of slurry.

A variety of popping slurry compositions may be utilized in a microwave popcorn article. The popping slurry composition may include an oil/fat component. The term “oil/fat component” or variants thereof may refer to oil, fat, or mixtures thereof included within the popping slurry. The oil/fat slurry may comprise blends of oil(s) and/or fat(s) if desired.

Partially hydrogenated soybean oil (PHSO) is a widely utilized oil in microwave popping, and may be utilized in microwave popcorn products presently disclosed. Partially hydrogenated soybean oils may contain a substantial amount of trans-fatty acids. If low trans-oil/fat material is desired, one readily available and usable oil/fat may be palm oil. Although palm oil may be acceptable in many instances, it may be nutritionally undesirable due to its saturated fat content.

Other low trans-fatty acid compositions suitable for use in microwave popcorn compositions may be used. Examples may be found in PCT WO 2006/004906, published Jan. 12, 2006, incorporated herein by reference.

The oil/fat component may be selected from material which may be relatively solid under storage conditions but may become liquid under the conditions of a microwave popping operation. The oil/fat component may facilitate heat retention and distribution over popped flakes during the microwave popping process. To facilitate this, the oil/fat or oil/fat blend may be selected to have a Mettler drop point (or melting point) no greater than about 140° F. (60° C.) and often in the range of about 100° F. to 135° F. (37.8-57.2° C.).

The oil/fat component may comprise at least about 50% by weight of the (non-popcorn) slurry and often about 80%-100% by weight of the slurry. The oil/fat component may be provided in an amount by weight of unpopped popcorn kernels within the range of about 10% to 40%.

Utilizing salt (often sodium chloride) may be desirable for facilitating and enhancing flavor. However, if the salt within the popping bag is likely to provide a burning or scorching problem for a given formulation, it may be preferable to either use minimal or no amounts of salt.

The popping slurry may include additional flavors and/or colors as required for enhancing the flavor and visual impact of the popcorn product. Flavor and color ingredients may be provided separately or as part of the same additive. The flavor and color ingredients together may comprise at least about 0.05% and usually not more than about 3% of the slurry, by weight. Usable color or flavor ingredients may include, as examples, beta carotene, various FD & C dyes, various FD & C lakes, annatto, turmeric and paprika.

A common and/or desirable texturized microwave popcorn product may have a sweet taste. Often candy glaze popcorn products made with a radiant heat glaze addition may be quite sweet and the consumer may expect a sweet taste when the popcorn includes a hard, glossy, coating thereon. A concentrated texturizing composition may not impart a substantial, sweet taste to the popcorn, at least for provision of a satisfactorily sweet taste to many U.S. consumers. As a result, it may be desirable to provide an additional artificial sweetener. The sweetener may be provided in the bag with the unpopped popcorn kernels, which may provide for a “sweet” taste in the resulting texturized microwave popcorn.

A usable, microwave stable sweetener that may be used, even in the presence of salt, is the sweetener sucralose, available from Tate and Lyle of Decatur, Ill., 62626, under the trade designation “Splenda®.” Utilization of sucralose in microwave popcorn operations, even in the presence of salt, may be found in U.S. Patent Publications 2002/0127306 and 2003/0012853, incorporated herein by reference. The sweetener may generally be used in at least a “sweetening effective amount,” which may mean an amount sufficient for providing a sweet taste to the consumer. The sweetener may be present in the slurry composition in an amount by weight based on total slurry composition (without popcorn) in the range of about 0.004% -0.30%, often about 0.1% -0.15%. The amount of sucralose used, based upon the weight of the unpopped popcorn kernels, for imparting a sweet taste may be in the range of about 0.0001 to 0.015%, by weight.

### IV. AN EXAMPLE COMMERCIAL PRODUCT AND ITS USE

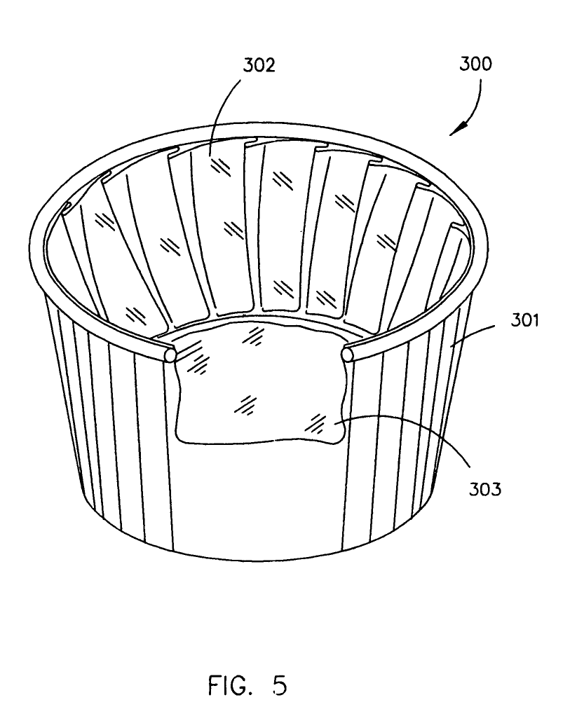

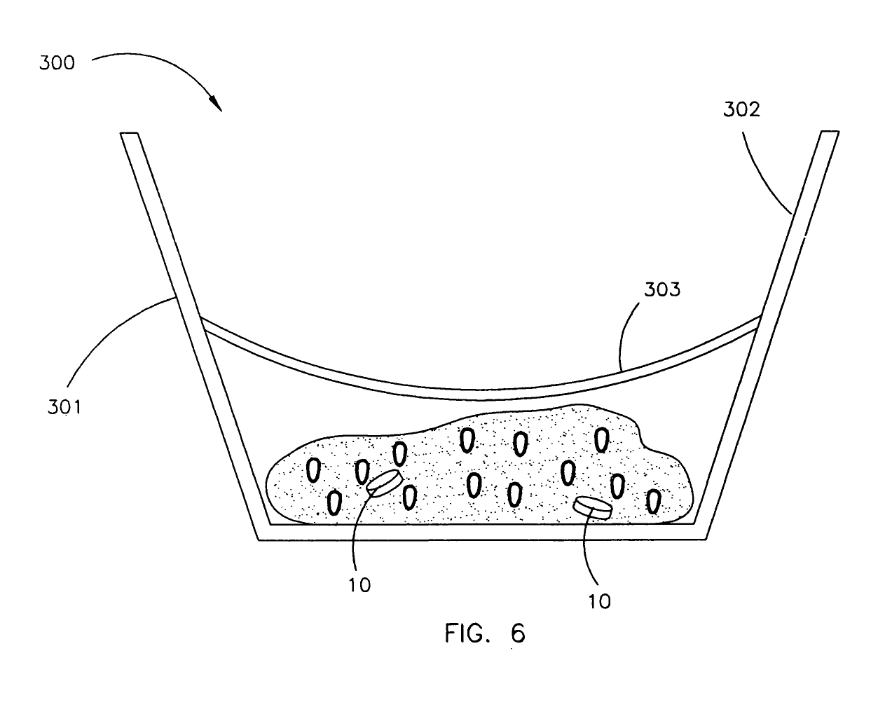

A variety of microwave popcorn packages have been developed. Often, flexible bag arrangements or tub arrangements may be used. The techniques subsequently described may be used in connection with either arrangement. With respect to FIGS. 1-4, application of the techniques in connection with a flexible bag arrangement is described. In FIGS. 5 and 6, application of the techniques in connection with a tub arrangement is depicted.

Flexible and expandable microwave popcorn arrangements using bags may involve a collapsed paper or treated paper package having a microwave interactive sheet receptor or susceptor operably positioned therein with a microwaveable popcorn composition positioned in covering relation or in thermoconductive relation to a microwave interactive construction. For many conventional microwave popcorn bag arrangements, the package may be folded into a tri-fold configuration during storage and prior to use. The tri-fold may be positioned in a moisture barrier storage over wrap for enhancing shelf life of the contents.

Reference numeral 1, FIG. 1, depicts an example flexible microwaveable popcorn bag or package usable with techniques according to the present disclosure. In FIG. 1 the popcorn package 1 is depicted in a conventional “tri-fold” configuration 2, for storage. In FIG. 1 the tri-fold 2 is sealed within a storage over wrap 3. A usable storage over wrap 3 may comprise a 90-140 gauge, biaxially oriented, polypropylene, although other materials may be used.

After removal from the overwrap 3, the microwaveable popcorn package 1 may be positioned in a microwave oven for popping the popcorn. After opening, the overwrap 3 may be discarded. In FIG. 1, the combination of the package 1 and over wrap 3 are referenced together as a commercial microwave popcorn product 1A.

Still referring to FIG. 1, the microwave popcorn package 1 has two opposite sides 5, 6; each side 5, 6 is discussed in detail below and comprises two side gusset outside edges along which creases are located.

As indicated, the package range of 1 depicted in FIG. 1 is shown as a “tri-fold.” It will be apparent, however, that techniques according to the present disclosure may be utilized in other package arrangements.

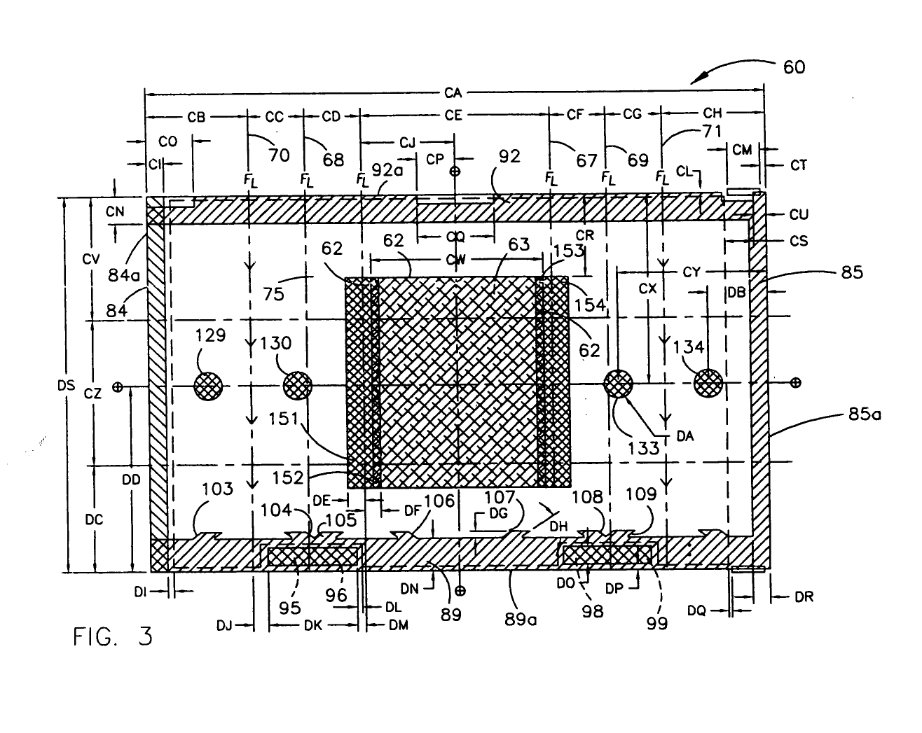

In FIG. 2, a top plan view of microwaveable popcorn package 1 is schematically shown in an unfolded orientation, much as it may be positioned in a microwave oven for popping an internally received popcorn charge but before expansion. In FIG. 2, lines 11 and 12 indicate fold lines which define central region 13 in the arrangement 1. The lines 11 and 12 indicate folds to form the tri-fold, FIG. 1. In central region 13 the unpopped popcorn charge may be positioned in an orientation against and, when oriented according to FIG. 2, above a portion of the bag 1 in which a microwave interactive construction (or susceptor) is preferably positioned. The term “microwave interactive” is meant to refer to a material which absorbs energy and becomes hot upon exposure to microwave energy in a microwave oven.

During a popping operation, moisture inside the popcorn kernels may absorb microwave energy generating sufficient steam and heat for kernel popping and expansion of bag 1. In addition, microwave interactive material may absorb microwave energy and dissipate heat to the popcorn charge. The microwave interactive material may occupy at least central region 13 (internally) to be in greater thermoconductive contact with a portion of that region than with any other portion of the interior of the popcorn package 1. Some of the microwave interactive material (by area or weight) may be positioned in thermoconductive contact with a region of the bag interior wherein the microwave interactive material may be covered by the popping charge when the package 1 is positioned in the microwave oven for use. This may lead to efficient utilization of microwave interactive material and efficient heat transfer or heat retention characteristics in connection with a popcorn popping process. This technique may be used in many conventional arrangements, such as the incorporated references.

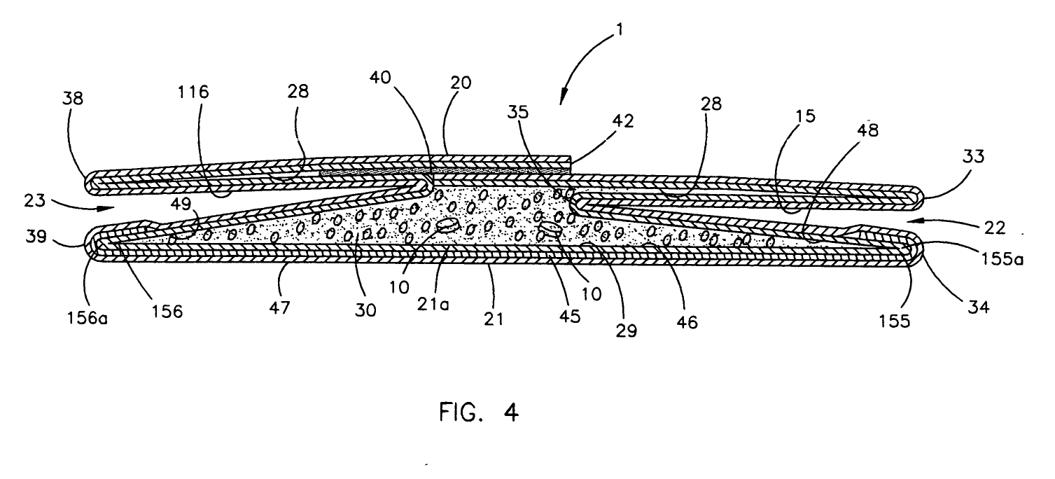

Attention is now directed to FIG. 4, a cross-sectional view taken generally along line 5-5, FIG. 2. From a review of FIG. 4, it will be understood the popcorn package may comprise the construction defining first and second opposite face panels 20 and 21 joined by first and second opposite, inwardly directed side gussets 22 and 23. By “inwardly directed” in this context, it may mean that in the cross-section of FIG. 4, gussets 22 and 23 point or extend toward one another.

The gussets 22 and 23 may separate popcorn package 1 into first and second expandable tubes 28 and 29. The popcorn charge 30 may be substantially positioned and substantially retained within one of the tubes, in this instance tube 29. The other tube, tube 28 may be collapsed prior to popping. Tube 28 may be sealed closed by temporary heat seats prior to the popping operation.

The popcorn charge 30 inside of package 1 may include unpopped popcorn kernels, a popping slurry 30, and a solid concentrated texturizing composition 10.

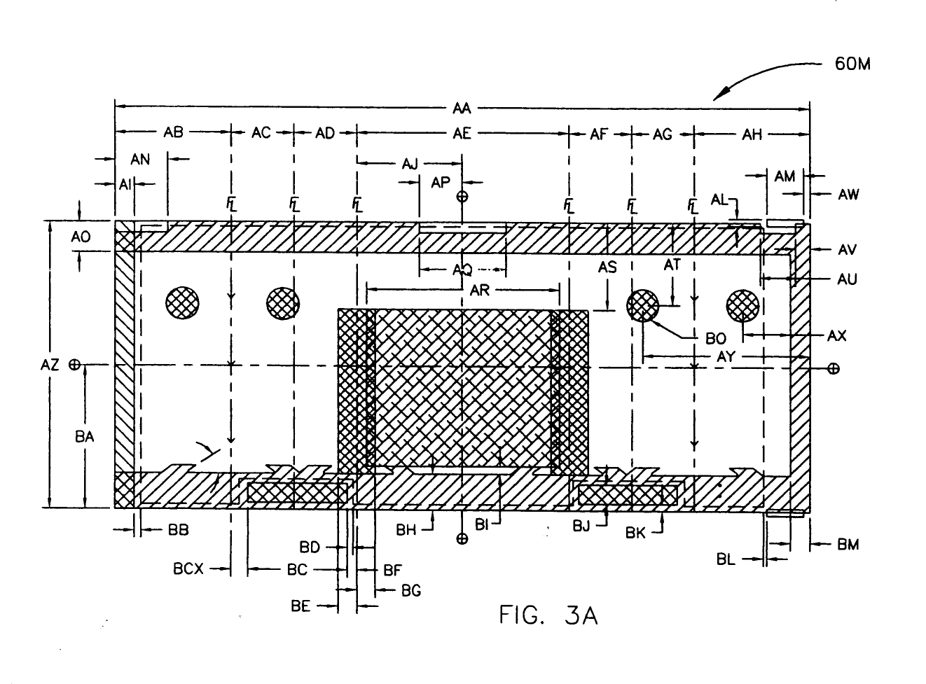

Referring to FIG. 4, the side gusset 22 may comprise outwardly directed edge creases or folds 33 and 34, fold 34 being adjacent face panel 21 and fold 33 being adjacent face panel 20; and, inwardly directed, central, fold 35. Similarly, gusset 23 may comprise outwardly directed edge creases or folds 38 and 39; and, inwardly directed, central fold 40; fold 39 being adjacent face panel 21 and fold 38 being adjacent face panel 20. Construction 1, for the arrangement shown in FIG. 3, may be folded from a two-ply sheet of material and panel 20 may include central longitudinal seam 42. Folds 33, 34, 35, 38, 39, and 40 are known for flexible microwave packaging, for example, as shown in U.S. Pat. Nos. 5,044,777, 5,195,829, and 5,650,084, incorporated herein by reference. Further, such folds are described in PCT WO 2006/004906, published Jan. 12, 2006, and in PCT WO 2005/080225, published Sep. 1, 2005, both PCT publications being incorporated herein by reference.

Underneath popcorn charge 30 package 1 may include microwave interactive construction or susceptor 45. The microwave interactive construction or susceptor 45 may be of conventional design. For example, the susceptor 45 may comprise a metallized polyester film.

In FIG. 4, the susceptor 45 may be positioned between layers of ply 46 and 47 from which the flexible construction 1 may be folded. Even with the susceptor 45 positioned between flexible sheets 46 and 47, arrangement 1 may be referenced as 2-ply. In the arrangement shown, the susceptor 45 may only occupy a portion of the area between the plies 46 and 47. The plies 46 and 47 may comprise a paper material, which may often be treated. Conventional techniques may be used and descriptions of example materials may be provided in PCT WO 2005/080225, published Sep. 1, 2005, incorporated herein by reference.

Still referring to FIG. 4, in region 21a an inside surface panel 21 is shown. Region 21a may define an unpopped popcorn charge retention surface. The unpopped popcorn charge and popping slurry 30 and solid concentrated texturizing composition 10 may be positioned in contact with surface 21a, often sitting on surface 21a where package 1 is positioned in a microwave oven for popping. The gusset 23 may include a panel section 49 adjacent to and integral with face panel 21. The gusset 22 may include a panel section 48 adjacent to, and integral with, face panel 21.

Attention is now directed to FIG. 3. FIG. 3 is a top plan view of a bag blank, panel, or sheet 60 from which an arrangement, according to FIGS. 1, 2, and 5 may be folded. Usable features for the blank 60, including example features sometimes illustrated in FIG. 3, may be described in PCT Applications WO 2005/080225 and PCT WO 2006/004906, both incorporated herein by reference. As is discussed in those references, a variety of sealing arrangements may be used to provide desirable features in the bag 1. Various combinations of these examples may be implemented. The sealant fields indicated in FIG. 3 are meant to provide an example of a usable arrangement with many alternatives being possible.

The view of FIG. 3 may be referred to as the “back side” of sheet 60, i.e., the side 65 of sheet 60 that forms an interior surface of the assembled bag construction 1, FIG. 1. The side opposite the side view in FIG. 3 may be referred to as the “front side” and may form an exterior surface of bag construction 1. The mirror image arrangement may also be possible.

Still referring to FIG. 3, line segment 62 defines a region 63 within which most of the microwave interactive material, such as a microwave interactive material in construction 45, FIG. 4, would be associated. The microwave interactive construction, for example, interactive construction 45, FIG. 4, may be positioned on an interior, an exterior, or between plies 46 and 47. As an example, microwave interactive construction 45 is positioned between plies 46 and 47 of the blank 60.

A variety of adhesive patterns may be utilized between plies 46 and 47. Examples may be described in PCT WO 2005/080225, incorporated herein by reference.

Still referring to FIG. 3, line 66 may indicate where fold 34, FIG. 4, may be formed. Line 67 may indicate where fold 39, FIG. 4, may be formed. Folds or creases 34 and 39 may be outwardly directed folds or creases in opposite side gussets 22 and 23 adjacent one face 21. Surface 21a, FIG. 4, for positioning of a popcorn charge thereon may extend between the folds 34 and 39. Line 68 may correspond to fold 35 FIG. 4, Line 69 with fold 40 FIG. 4, line 70 with fold 33 FIG. 4, and line 71 with fold 38 FIG. 4. Region 75 between fold lines 66 and 68 may generally define gusset panel section 49, FIG. 4, and region 77 between fold lines 67 and 69 may generally define gusset panel section 48, FIG. 4.

In general, the tri-fold 1, FIG. 1, may be eventually formed by folding the overall arrangement 1 such that it folds along appropriately spaced regions perpendicular to lines 66, 67, 68, 69, 70, and 71. It will be understood that the latter folding may generally be after the bag construction, shown in FIG. 2, has been otherwise assembled.

Referring to FIG. 3, sealant field 84, along edge 84a and positioned on an opposite side of panel 60 from side 65, may be used to engage field 85 along edge 85a during folding, typically with applied heat and pressure, for forming the longitudinal seam as seen at 42, FIG. 4. During folding, various portions of field 89 along edge 89a of side 65 may line up with one another for forming various portions of end seal 90, FIG. 2, often with application of heat and pressure. Various portions of field 92, along edge 92a on side 65, shown in FIG. 3, may align with one another to form end seal 93, FIG. 2, with an application of heat and pressure. In general, field 92 may form a top edge 93 of the completed bag through which popped popcorn may be removed after popping. Sealant fields 95 and 96, on the opposite side of panel 60, FIG. 3, may align with each other when folding around fold line 68 is conducted and heat and pressure are applied for helping secure panel 60 in a preferred configuration along long end 90, FIG. 2, after folding. This may be analogous to the arrangement of U.S. Pat. No. 5,195,829, FIG. 1a, incorporated herein by reference. Similarly, sealant fields 98 and 99, on underside of panel 60, FIG. 3, may align with each other when the panel is folded around fold line 69 for providing a secure and preferred end configuration at 90, FIG. 2, when heat and pressure are applied.

Attention is now directed toward sealant fields 103, 104, 105, 106, 107, 108, 109, and 110. Analogous fields may be found in PCT WO 2005/080225 and PCT WO 2006/004906, both incorporated herein by reference. During folding, portions of fields 103-110 may align with each other for retaining selected portions of the panel adhered to one another, typically after application of pressure and heat, for providing a suitable configuration during expansion. Field 103 may engage field 104, field 105 may engage field 106, field 108 may engage field 107, and field 110 may engage field 109 during folding and after application of pressure and heat. Engagement of fields 105 and 106, and also fields 108 and 107, may retain selected portions of panels 48 and 49 against panel 21, FIG. 3, in regions in the collapsed bag 1 where the popcorn charge is not located. Sealant field 103 may fold against 104, and field 110 may fold against field 109, helping retain panels 115 and 116 sealed against panel 20, FIG. 4, in the collapsed bag 1. This may help to assure the popcorn charge 30, FIG. 4, is retained where desired in the arrangement. Advantages from this configuration may be found in U.S. Pat. No. 5,195,829 and in PCT WO 2005/080225 and 2006/004906, all incorporated herein by reference. It is noted that for the bag arrangement of U.S. Pat. No. 5,195,829, several fields in adjacent region 92 were also used. For the arrangements reflected by FIG. 3, these were not shown. However, they may optionally be used.

Attention is now directed to sealant fields 129, 130, 133, and 134. In typical bags, these may be used to ensure that panels 115 and 116 are sealed against panel 20, FIG. 4, so that the popcorn charge 30 may be substantially retained in tube 29, FIG. 4, and does not expand or spread substantially into tube 28 until desired during heating. In particular, fields 129 and 130 may be oriented to engage each other when the arrangement is folded about fold line 70 with the application of heat and pressure and fields 133 and 134 may be oriented to engage one another when the arrangement is folded about fold line 71 with application of heat and pressure. A similar arrangement may be found in U.S. Pat. No. 5,044,777, incorporated herein by reference.

Sealing may result from application of heat and pressure after folding to the region where the seal is located. For the various seats discussed, a sealant may be positioned on both adjoining paper surfaces for convenience. However, a sealant may only be positioned on one side. The two sides may be folded together following the application of appropriate heat and pressure for forming a seat.

It may be noted that the sealant fields discussed may be configured to form seals with application of heat and pressure. Alternate types of seals, for example cold seals, may be implemented in arrangements according to the present disclosure.

In the remaining discussion of sealant fields and surface 65 and package arrangement 60, FIG. 3, options may be provided for preferred management and control of wicking and flow characteristics of the oil/fat(s) (i.e., the slurry) in the popcorn charge during storage, handling, and use. It may be noted the seats and fields may be used in one of two ways. First, sealant fields may be used for forming an insulating seal and for managing location of oil/fat(s) by insulating it from portions of the package. Secondly, an application of the seal to a paper surface may change the surface tension properties of a surface and its interaction with the oil/fat(s) material. The properties of the seal may be used to operate to contain the oil/fat(s) material. Sealant fields may be applied to the paper at preferred locations where it is desirable to inhibit flow of the oil/fat(s) material as it liquefies. Examples of the techniques described may be found in PCT WO 2005/080225, published Sep. 1, 2005, incorporated herein by reference.

For the example shown in FIG. 3, fields 151 and 152 may be oriented to engage one another during folding about fold line 66. Fields 153 and 154 may be oriented to engage one another during folding about fold line 67. The seals that result from fields 151 and 152, 153, and 154 may protect against flow of oil/fat into the popcorn charge position in region 63 in the closed, folded popcorn package from flowing to gusset folds 39, 34, FIG. 4. This may help inhibit leakage during storage and use since damage may occur where creasing takes place.

The particular package blank 60 depicted in FIG. 3, may be configured for manufacture of a full size or regular size popcorn bag. The dimensions indicated by the letters in FIG. 3 are as follows: CA=19.1250 inches; CB=3.1875 inches; CC=1.7188 inches; CD=1.7188 inches; CE=5.8750 inches; CF=1.7188 inches; CG=1.7188 inches; CH=3.1875 inches; CI=0.5 inches; CJ=2.9375 inches; CK=0.25 inches; CL=0.2 inches; CM=1.1562 inches; CN=0.8579 inches; CO=1.4375 inches; CP=1.1875 inches; CQ=2.375 inches; CR=2.5625 inches; CS=0.9375 inches; CT=0.1875 inches; CU—0.5 inches; CV=4.0 inches; CX=5.8750 inches; CY=4.5313 inches; CZ=4.0 inches; DA=0.75 inch diameter; DB=1.8438 inches; DC=3.6250 inches; DD=5.8125 inches; DE=0.5 inches; DF=0.5 inches; DG=0.25 inches; DH=37o; DI=0.125 inches; DJ=0.25 inches; DK=2.9375 inches; DL=0.125 inches; DM=0.25 inches; DN=1 inch; DO=0.625 inches; DP=0.2188 inches; DQ=0.0625 inches; DR=0.625 inches; and DS=11.625 inches. Other dimensions may be taken from scale. A variety of package arrangements may be utilized. Some usable alternatives may be described in PCT WO 2005/080225, incorporated herein by reference. Others may be used with the applications and techniques described herein.

In FIG. 3A, a package blank 60M in the useable form of a mini bag is provided in accord with the general descriptions above. The various sealant fields indicated may have analogous purposes to those described above for package blank 60, FIG. 3. In FIG. 3A, the various dimensions indicated are as follows: AA=19.125 inches; AB=3.1875 inches; AC=1.7188 inches; AD=1.7188 inches; AE=5.875 inches; AF=1.7188 inches; AG=1.7188 inches; AH=3.1875 inches; AI=0.5 inches; AJ=2.9375 inches; AK=0.25 inches; AL=0.2 inches; AM=1.1562 inches; AN=1.4375 inches; AO=0.8579 inches; AP=1.1875 inches; AQ=2.375 inches; AR=5.375 inches; AS=2.375 inches; AT=2.25 inches; AU=0.9375 inches; AQ=1.875 inches; AV=0.5 inches; AX=1.8438 inches; AY=4.5313 inches; AZ=8 inches; BA=4 inches; BB=0.125 inches; BC=2.9375 inches; BCX=0.25 inch; BD=0.125 inches; BE=0.5 inches; BF=0.25 inches; BG=0.5 inches; BH=1 inch; BI=0.25 inches; BJ=0.625 inches; BK=0.2188 inches; BL=0.0625 inches; BM=0.625 inches; and BO=0.75 inch diameter. Other dimensions may be taken from scale.

In FIG. 5, a tub product 300 for application of the techniques described herein is shown. Tub product 300 may comprise a paperboard container 301 and a flexible balloon 302. A microwave charge may be contained within tub product 300 and often within a subpackage positioned in central region 303 underneath balloon 302. The package may be positioned in a microwave oven, and energy applied to pop popcorn. During the popping process the balloon 302 may invert. After removal of the tub from the oven, the balloon remnant(s) may be removed.

Attention is now directed to FIG. 6. FIG. 6 is a cross-sectional view of tub product 300 in FIG. 5. The tub product 300 may be comprised of a paperboard container 301, a flexible balloon 302, and/or a popcorn charge under the central region 303. Within the popcorn charge may be a solid concentrated texturizing composition 10. The package may be positioned in a microwave oven, and energy may be applied for popping popcorn. During the popping process, the balloon 302 may invert. After removal of the tub from the oven, the balloon remnant(s) may be removed.

### V. EXAMPLES

For the examples described, packaging in accord with FIGS. 1 and 2 may be made, for example, in accord with the specific example of FIGS. 3 and 4, or other examples as described in PCT application WO 2005/080225, incorporated herein by reference. The package blank 60 may be formed for a regular popcorn charge (unpopped kernels) of about 65 grams. Example dimensions for such package blanks may be found above.

The components for the popcorn slurry within the bag may comprise corn, oil, sucralose, and salt in the following amounts: unpopped microwave popcorn, 65 grams; oil (palm), 25 grams; sweetener (sucralose), 0.02 grams; salt (sodium chloride), 0.6 grams.

One example of a microwave popcorn product may utilize a texturing composition. An example texturizing composition may be a tablet that upon heating breaks down and releases an aroma into the atmosphere, making the food product more desirable for consumption. The texturizing composition form may be oval, round, square, uniform or non-uniform in shape. The texturizing composition form may include other shapes and geometries other than those listed above and may be uniform or non-uniform. The texturizing composition may be in compact form. The size may be large enough to carry enough material for delivering the desired texture, aroma, and/or flavor.

Utilizing a texturizing composition in tablet and/or pellet form may be advantageous. A texturizing composition in a compact form may allow control over the taste and other organoleptic properties of finished food products because the taste and organoleptic properties of a finished food product may depend upon the texture, aroma, and/or flavor. Food products that normally do not release a large amount of aroma in the cooking process may release a large amount of more desirable and pronounced aroma when utilizing a glaze in tablet and/or pellet form.

A texturizing composition in a compact form may comprise a carbohydrate with at least one aroma producing compound and/or a flavoring. Carbohydrates that may be utilized include starch, sucrose, corn syrup solids, maltodextrin, gelatin, gum acerbic, and hydrocolloids, as well as other carbohydrates. Aromas that may be utilized include a wide range of compounds. Some examples, which are not meant to be limiting, are listed in the following table.

TABLE 1
Potential aromatic compounds

| | | |
|---|---|---|
| Aldehyde C-16 | Cumarin | Neroline Bromalia |
| Aldehyde C-18 | Cyclogalbanate | Nopyl Acetate |
| Aldehyde C-19 | Cyclorose | Orange Oil |
| Aldehyde C-20 | Dep(Di Etyl Phthalate) | P.E.M.E. |
| Aldehyde C-8 | DHM(Di Hydro | Para Cresyl Acetate |
| | Mercenol) | |
| Aldehyde C-9 | Di Hydro Iso Jasmone | Para Cresyl Phenyl |
| | | Acetate |
| Aldron | DMHQ(Dimethyl Hydro | Patcholi |
| | Quinone) | |
| Allyl Amyl Glycolate | DMO (Di Methyl | Petit Grain |
| | Octonol) | |
| Alpha Amyl Cinnamic | Ethyl Maltol | Phenyl Acetic Acid |
| Aldehyde | | |
| Alpha Damascon | Ethyl Vanilline | Phenyl Ethyl Acetate |
| Alpha Ionone | Eucalyptol | Phenyl Ethyl Alcohol |

*Partial list obtained from Shreeji Aroma, 138 Princess Street, Govind Building, Mumbai, India

The texturizing composition may include a particle that breaks down upon heating and releases a flavor onto the food product making the food product more desirable for consumption. This texturizing composition may be advantageous because control over the taste and other organoleptic properties of the texturized microwave popcorn product may be largely dependent on aroma and flavor. This may allow food products with a mild, uniform flavor profile to have a more uneven, non-uniform, and pronounced flavor making it more desirable and flavorful. The flavor particle shape may be oval, round, and square, as well as other shapes and geometries, uniform or non-uniform. Additionally, the size of the texturizing composition particles may be large enough to contain enough material to deliver the desired flavor. The particle may be comprised of a carbohydrate and the desired flavor compounds, as well as other materials suitable for a texturizing composition. Examples of a carbohydrate may include starch, sucrose, corn syrup solids, and maltodextrin, as well as other materials.

The texturizing composition may include a tablet that breaks down upon heating and releases an ingredient into the food product. The texturizing composition may act as a mechanism for delivering at least one ingredient into or onto the food product that normally would be sensitive, inefficient, or impossible to deliver because of chemical or physical interactions within the food product. The form of the tablet may include differing shapes and geometries, such as an oval, a sphere, a cylinder, a square, as well as other uniform and/or non-uniform shapes. The size may be large enough to provide enough material to deliver the desired ingredient. Examples of a tablet composition may include a carbohydrate and the ingredient to be delivered to the food, as well as other suitable materials. Examples of a carbohydrate may include, starch, sucrose, corn syrup solids, maltodextrin, gelatin, gum acacia, and hydrocolloids, as well as other suitable materials. The texturizing composition comprising a tablet that breaks down upon heating may include a core of salt in combination with an outer layer of a sweetener, such as sucrose, or a carbohydrate.

In a microwave popcorn product, the texturizing composition may exist in a solid and concentrated form, such as a pellet. A typical pellet may be approximately 0.5 grams to 1.5 grams. The pellets may be allocated with the popped popcorn kernels, often 60 to 80 grams of popcorn kernels, and the oil matrix, approximately 15 to 40 grams. During the heating process, the oil may heat and convert from solid phase to liquid phase and in turn heat the unpopped popcorn kernels. The heated popcorn kernels may begin to pop. Simultaneously, the microwave and susceptor, the popping kernels, and the heated oil may transfer heat to the solid texturizing composition in compact form and may convert the solid texturizing composition into a liquid phase. The liquid texturizing composition may be then at least partially dispersed over the popped popcorn kernels by the popping action of the kernels. After the texturizing composition is dispersed over the popped kernels and the kernels stop popping, the texturizing composition may cool quickly and convert to solid phase. The microwave popcorn popping process utilizing a solid and compact texturizing composition may result in popped popcorn kernels at least partially covered with the texturizing composition.

The texturizing composition may be stable under prolonged exposure to increased microwave energy and heat under popping conditions, typically 1.5-5 minutes within the microwave oven. Additionally, it may be a general requirement that there be little or no salt in the entire contents of the popcorn bag, as there may be burning or scorching problems with the ultimate product. By using a texturizing composition in the form of a concentrated solid, a pellet for example, more stability may be achieved.

In one example, the texturizing composition pellet may be in a more centralized location within the popcorn and oil mixture compared to a powder form. The concentrated solid texturizing composition in the form of a compact solid may reduce the surface area of the texturizing composition. When the texturizing composition is in the form of a pellet and not a powder or granular form, the rate at which the texturizing composition converts from a solid phase to a liquid phase may occur later in the cooking process, thus allowing the oil to act more effectively to pop the corn. This may reduce the overall time the product is required to be exposed to microwave energy. The texturizing composition may be exposed to less microwave energy, and less of a chance for burning and scorching may exist.

Further, the microwave popcorn product may require less oil to effectively pop the unpopped popcorn kernels. Reducing the surface area of the solid texturizing composition may reduce the amount of oil needed to surround the solid texturizing composition. Because less oil may be required to surround the solid texturizing composition, more of the oil may be available to coat the unpopped popcorn and more efficiently heat and pop the popcorn kernels. The popcorn may pop more rapidly and with less unpopped kernels in the presence of oil.

Table 2 below provides an example composition. It is noted that the partially hydrogenated soybean oil, of course, may be exchanged for an alternate oil such as palm oil or another oil if desired.

The following formulation is meant to be an example only. Variations in flavorants and colorants may also be utilized.

TABLE 2
AN EXEMPLARY MICROWAVE POPCORN PRODUCT
COMPOSITION

| Ingredient | Wt % in Package |
|---|---|
| 1. Popped Popcorn Kernels | 53.77% |
| 2. Slurry | |
| a. Caramel Powder | 2.57% |
| b. Lecithin | .51% |
| c. Oil (for ex. PHSO) | 35.45% |
| d. Sucralose | 0.04% |
| 3. Pellet for providing texture, aroma, | 7.67% |
| and/or flavor (compact form) | |

An example product may comprise either a mini bag or a regular size bag characterized above, or a tub. A variety of textures, aromas, colors, and/or flavors may be used as long as they are stable to the conditions of microwave popping.

One improved microwave popcorn product may comprise 50% to 80% popcorn; 7% to 30% texturizing composition; 0.05% -0.2%. by wt., microwave stable sweetener, such as sucralose; 5% to 30% oil; and 0.5% to 3% additional flavorant and/or colorant. An emulsifier, such as lecithin, may be used in an amount of 0.25% to 2%, for facilitating formation of the slurry and distribution over the popcorn.

It is believed that the product and method for providing texture, aroma, and/or flavor for microwave popcorn of the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A texturizing composition, comprising: a texturizing substance,
wherein the texturizing substance is in a compact form.

2. The texturizing composition in claim 1, wherein the compact form includes at least one of a sphere, a pellet, an oval, a cylinder, a cube, a disk, and a rectangle.

3. The texturizing composition in claim 1, further comprising a sweetener.

4. The texturizing composition in claim 1, further comprising a flavoring.

5. The texturizing composition in claim 1, further comprising an emulsifier.

6. The texturizing composition in claim 1, further comprising a coloring.

7. The texturizing composition in claim 1, further comprising an aromatic component.

8. The texturizing composition in claim 7, wherein the aromatic component is controlled release aromatic component.

9. The texturizing composition in claim 1, wherein the glazing tablet further comprises a first layer and at least a second layer.

10. The texturizing composition in claim 9, wherein the first layer includes a core of salt and the second layer includes a carbohydrate.

11. A microwave popcorn product, comprising:
unpopped microwave popcorn kernels, the unpopped microwave popcorn kernels provided in an amount about 50 to 80% by weight;
a slurry including at least one of oil and fat, the slurry provided in an amount of 5 to 30% by weight; and
a texturizing substance,
wherein the texturizing substance is in a compact form.

12. The microwave popcorn product in claim 11, wherein the microwave popcorn product further comprises a sweetener.

13. The microwave popcorn product in claim 11, wherein the concentrated solid is in the form of at least one of a sphere, a pellet, an oval, a cylinder, a cube, a disk, and a rectangle.

14. The microwave popcorn product in claim 11, wherein the texturizing composition includes a coloring.

15. The microwave popcorn product in claim 11, wherein the texturizing composition includes a flavoring.

16. The microwave popcorn product in claim 11, further comprising an emulsifier.

17. The microwave popcorn product in claim 11, further comprising an aromatic component.

18. A method for providing a microwave popcorn product, comprising:
providing a bag suitable for containing and cooking a microwave popcorn;
filling the bag with the microwave popcorn, a slurry including at least one of an edible fat and an edible oil, and a texturizing composition, the texturizing composition in a compact form; and
seating the bag.
